(19) United States
(12) Patent Application Publication
(10) Pub. No.: US 2009/0139669 A1
(43) Pub. Date: Jun. 4, 2009

(54) SHADELINE PERSONAL SHADE

(75) Inventor: Claude Robin, Lorgues (FR)

Correspondence Address: Jeffrey Jue;Apt. D, 207 S. Oakland Ave., Pasadena, CA, 91101, US

(73) Assignee: LES JARDINS, Los Angeles, CA (US)

(21) Appl. No.: 12/366,511

(22) Filed: Feb. 5, 2009

(51) Int. Cl. E06B 9/24; A44B 21/00

(52) U.S. Cl. 160/351; 24/457

(57) ABSTRACT

A Shadeline™ personal shade is described. The shade may include a visor attached to an arm. The visor may be at least semi-transparent, and may be configured to inhibit incident light from passing through the visor while allowing sufficient light to pass through the visor such that a user can see through the visor. The arm may be flexible, such that the visor may be positioned to inhibit incident light from different source directions. The shade may further include a clamp, such that the shade may be attached to another object such as an article of furniture.

### FIELD OF THE INVENTION

The present invention relates generally to devices for providing shade from the sun, or other protection, to persons, and more specifically to a personal shade apparatus.

### BACKGROUND OF THE INVENTION

Umbrellas have traditionally been used to provide protection from rain and sun in a variety of leisure and work-related situations. For instance, hand-held umbrellas shelter persons from rain. Larger umbrellas offer protection from exposure to the sun while on a beach. Large canopied umbrellas have also been developed for backyard use in recreational activities such as for shading persons while reading, eating, and the like.

Umbrellas conventionally have a rigid, elongated support post with a free end and an extendable canopy at an end distal from the free end. The canopy is typically supported by a plurality of ribs radiating from the post, and is generally made of a fabric material such as a canvas or plastic weave, or a solid plastic piece with a fixed orientation with respect to the post. The canopy typically extends to a perimeter of between about three and six feet for a personal umbrella and up to eight feet for a larger beach or backyard (recreational) umbrella. Such larger beach umbrellas typically have an elongated post with a tapered end for insertion of the post into a support such as the sand and/or a weighted base to support the post vertically and to resist the umbrella from tipping, especially during windy conditions-features that can effectively stabilize an umbrella canopy, but which also make movement and positioning of the umbrellas cumbersome.

An alternative to umbrellas for protection from the hot sun is wearing a hat. However, hats commonly retain heat, even if mesh fabrics are used in the hats. Moreover, hats often cannot be positioned to provide a person adequate shade and protection from the sun. Hats can be further cumbersome due to their other undesirable effects on a user's hair/head.

Accordingly, there remains a need in the art for improved personal shades, which provide new and useful features to users.

### SUMMARY OF THE INVENTION

The present invention describes a personal shade, including a Shadeline™ personal shade in certain embodiments.

In one embodiment, a personal shade may include an arm having first and second ends, and a visor connected to the first end of the arm. The arm of the personal shade may be flexible and configured to allow positioning of the visor to inhibit incident light (e.g., sunlight). The arm may be sufficiently stiff to support the visor in various positions, and may comprise, for example, a malleable metal wire or tube.

In one embodiment, the visor of the personal shade may comprise a material configured to inhibit substantially all ultraviolet incident light from passing through the material. The visor may likewise be configured to control the transmission of light of other wavelengths in the electromagnetic spectrum (e.g., the visible spectrum).

In one embodiment, the visor of the personal shade may be at least semi-transparent in at least one dimension (e.g., in the visible spectrum). Accordingly, a user may be able to see through the visor while still receiving a certain degree of protection/shade from the visor. For example, the visor may be tinted.

In one embodiment, the visor of the personal shade may comprise a material configured to inhibit incident light from passing through the material while allowing sufficient light to pass through the material such that a user can see through the material. For example, the visor may comprise at least one of plastic, glass and an electrochromatic material.

Alternatively, in one embodiment, the visor may comprise at least one of a plastic, glass, electrochromatic material, optoelectronic material, cloth fabric, metal and ceramic, and may be opaque.

In one embodiment, the visor of the personal shade may be configured and/or shaped to outline and shade a user's face, while leaving the user's body exposed to incident light.

In one embodiment, a personal shade may include a clamp connected to the second end of the arm, wherein the clamp is configured to be repeatedly attached to and detached from another object, such as an article of furniture. Articles of furniture may include, but are not limited to, chairs, lounge chairs, benches, beds, posts and tables.

As used herein, a layer component is said to be “transparent” when the layer or layers thereof permit at least 50% of the ambient electromagnetic radiation in relevant wavelengths (e.g., the visible spectrum) to be transmitted through the layer or layers. Similarly, components which permit some but less than 50% transmission of ambient electromagnetic radiation in relevant wavelengths are said to be “semi-transparent.”

Other features and advantages of the invention will be apparent from the accompanying drawings and from the detailed description. One or more of the above-disclosed embodiments, in addition to certain alternatives, are provided in further detail below with reference to the attached figures.

### BRIEF DESCRIPTION OF THE DRAWINGS

The invention is better understood from reading the following detailed description of the preferred embodiments, with reference to the accompanying figures in which:

FIG. 1 is a schematic representation of an embodiment of the present invention;

FIGS. 2A, 2B and 2C are side, front and top views, respectively, illustrating novel features of an embodiment of the present invention;

FIGS. 3A and 3B are perspective views of an embodiment of the present invention; and

FIG. 4 and 5 are illustrations of an embodiment of the present invention as used in a possible configuration.

Features, elements, and aspects of the invention that are referenced by the same numerals in different figures represent the same, equivalent, or similar features, elements, or aspects in accordance with one or more embodiments of the system.

### DETAILED DESCRIPTION OF THE EMBODIMENTS

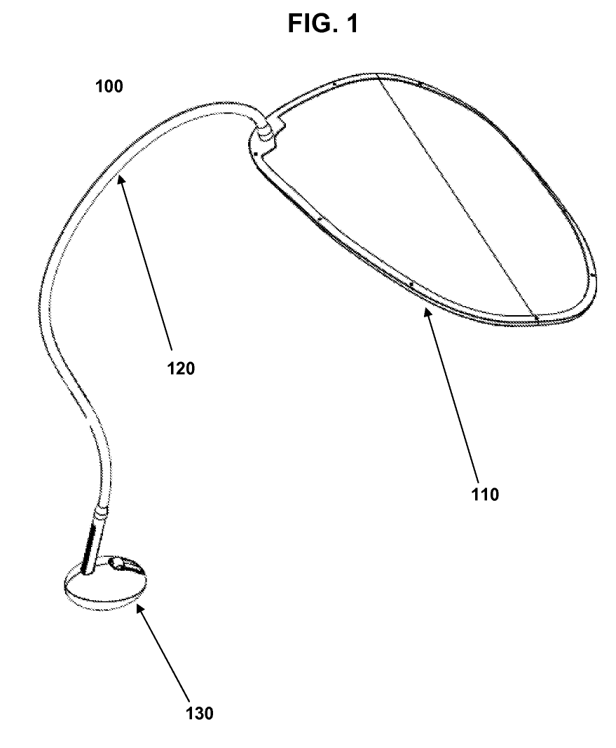

Referring to FIG. 1, a Shadeline™ personal shade 100 according to an embodiment of the present invention may comprise a visor 110 attached to an arm 120. The arm of the personal shade may be flexible and configured to allow positioning of the visor to inhibit incident light. The arm may be sufficiently stiff to support the visor in various positions, and may comprise, for example, a malleable metal wire or tube. A clamp 130 may also be attached to the arm 120.

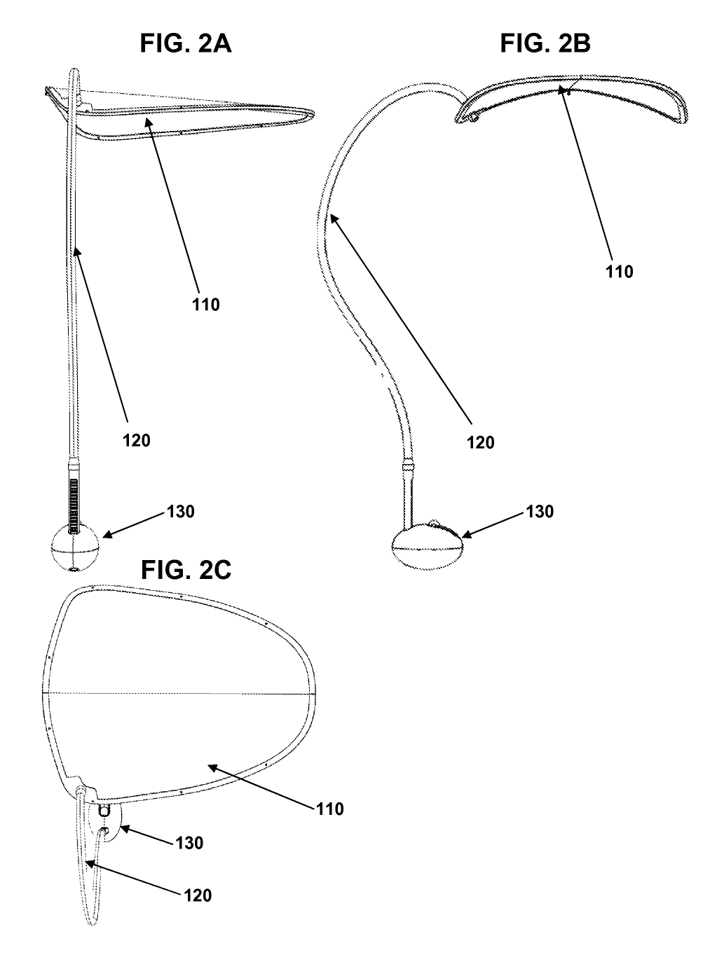

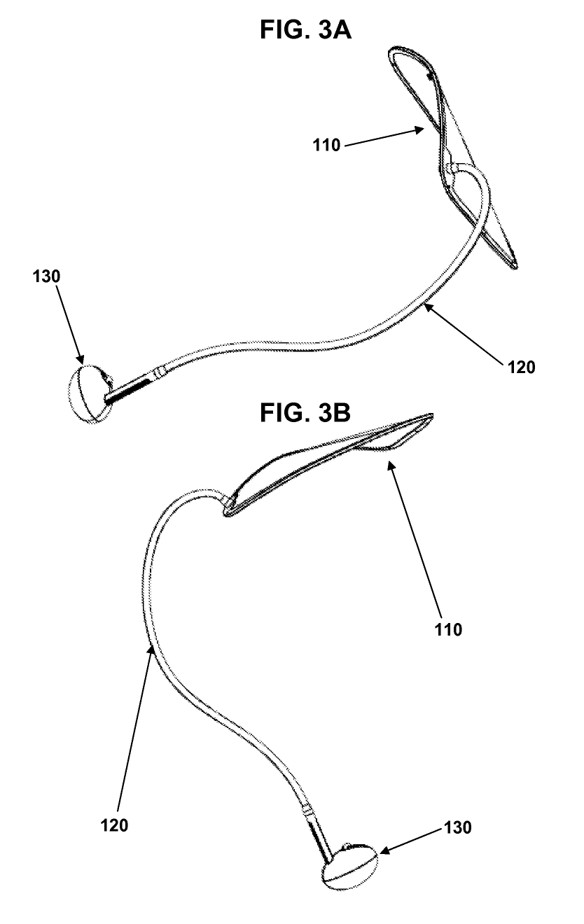

Referring to FIGS. 2A, 2B, 2C, 3A and 3B, the visor 110 of a personal shade according to the present invention may be configured and/or shaped to outline and shade a user's face, while leaving the user's body exposed to incident light. In certain exemplary embodiments, the visor 110 may comprise at least one of plastic, glass and an electrochromatic material, curved to frame a user's face.

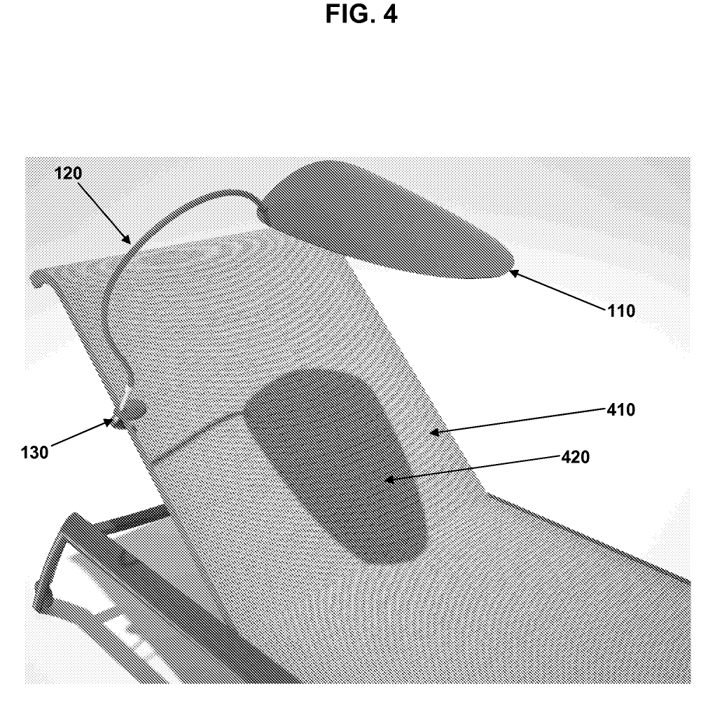

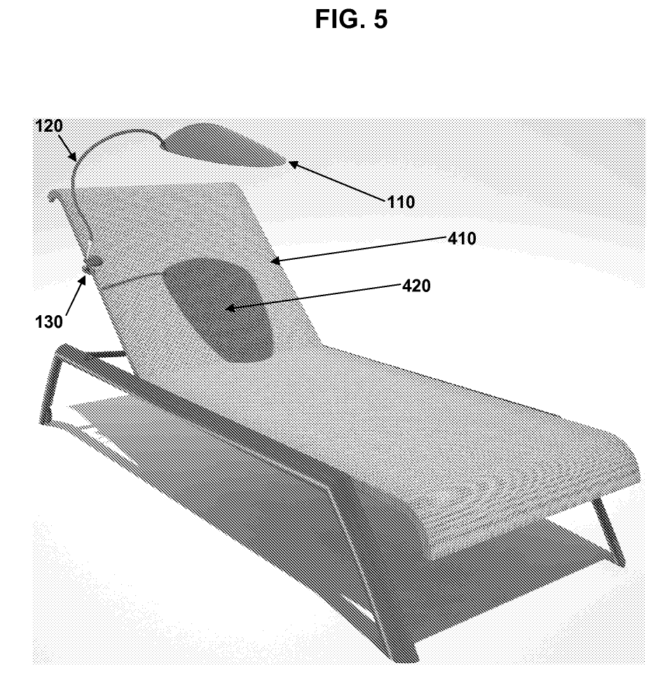

Referring to FIGS. 4 and 5, the visor 110 of the personal shade may comprise a material configured to inhibit substantially all ultraviolet incident light from passing through the material. The visor may likewise be configured to control the transmission of light of other wavelengths in the electromagnetic spectrum (e.g., the visible spectrum). The visor of the personal shade may also or alternatively be at least semi-transparent in at least one dimension (e.g., in the visible spectrum). Accordingly, a user may be able to see through the visor while still receiving a certain degree of protection/shade from the visor. For example, the visor may be tinted such that it blocks at least some incident light and casts an underlying shadow 420.

Alternatively, the visor 110 may be at least substantially opaque, for example comprising at least one of a plastic, glass, electrochromatic material, optoelectronic material, cloth fabric, metal and ceramic.

The clamp 130 of a personal shade according to embodiments of the present invention may be configured to be repeatedly attached to and detached from an article of furniture 410. Articles of furniture 410 may include, but are not limited to, chairs, lounge chairs, benches, beds, posts and tables.

For example, a user may clamp a Shadeline personal shade to a deck chair 410, and thereby shade his or her face from incident sunlight. Adjusting the position of the clamp 130 can allow the user to position the visor 110 in different positions to block light from different source directions. Additionally, where the arm 120 of the Shadeline™ personal shade is flexible, the user may position the visor 110 without changing the position of the clamp 130. In certain exemplary embodiments, the visor 110 is tinted such that the user can see through the visor 110, while still receiving a certain degree of protection from the visor (e.g., from potentially harmful ultraviolet radiation, rain, falling leaves, etc.). In certain exemplary embodiments, the visor 110 is shaped to frame a specific underlying area 420 (e.g., corresponding to the user's face). Advantages of such a visor 110 may include ease of configuration and transport, given that a corresponding personal shade may be smaller and lighter than a conventional umbrella. Additionally or alternatively, such a visor 110 may allow users to more-easily adjust their exposed areas (e.g., for sun tanning)

The present invention has been described above with reference to preferred features and embodiments. Those skilled in the art will recognize, however, that changes and modifications may be made in these preferred embodiments without departing from the scope of the present invention.

What is claimed is:

1. A personal shade, comprising an arm having first and second ends;
a visor connected to the first end of the arm; and
a clamp connected to the second end of the arm, wherein the clamp is configured to be repeatedly attached to and detached from an article of furniture.

2. The personal shade of claim 1, wherein the arm is flexible and configured to allow positioning of the visor to inhibit incident light.

3. The personal shade of claim 2, wherein the visor comprises a material configured to inhibit substantially all ultraviolet incident light from passing through the material.

4. The personal shade of claim 3, wherein the visor is at least semi-transparent in at least one dimension.

5 . The personal shade of claim 4, wherein the material is configured to inhibit incident light from passing through the material while allowing sufficient incident light to pass through the material such that a user can see through the material.

6. The personal shade of claim 5, wherein the visor is tinted.

7. The personal shade of claim 6, wherein the visor comprises a material selected from the group consisting of plastic, glass and an electrochromatic material.

8. The personal shade of claim 7, wherein the visor is configured to outline and shade a first area corresponding to a face of the user, while leaving a second area corresponding to a body of the user exposed to incident light.

9. The personal shade of claim 1, wherein the visor is configured to outline and shade a first area corresponding to a face of the user, while leaving a second area corresponding to a body of the user exposed to incident light, and wherein the visor comprises a material selected from the group consisting of plastic, glass, cloth fabric, metal, ceramic and an optoelectronic material.

10. The personal shade of claim 1, wherein the visor is configured to inhibit incident light from passing through the visor while allowing sufficient incident light to pass through the visor such that a user can see through the visor.

11. A personal shade, comprising an arm having first and second ends; and
a visor connected to the first end of the arm, wherein the visor comprises a material configured to inhibit incident light from passing through the material while allowing sufficient incident light to pass through the material such that a user can see through the material.

12. The personal shade of claim 11, wherein the material is configured to inhibit substantially all ultraviolet incident light from passing through the material.

13. The personal shade of claim 12, wherein the arm is configured to allow the user to positioning the visor to inhibit incident light from a given source direction.

14. The personal shade of claim 13, further comprising a clamp connected to the second end of the arm, wherein the clamp is configured to be repeatedly attached to and detached from an article of furniture.

15. The personal shade of claim 14, wherein the visor is configured to outline and shade a first area corresponding to a face of the user, while leaving a second area corresponding to a body of the user exposed to incident light.

16. A personal shade, comprising an arm having first and second ends; and
a visor connected to the first end of the arm, wherein the visor is at least semi-transparent in the visual spectrum, and
wherein the visor is configured to outline and shade a first area corresponding to a face of the user, while leaving a second area corresponding to a body of the user exposed to incident light.

17. The personal shade of claim 16, wherein the visor is tinted such that the visor inhibits at least some incident light from passing through the visor while allowing a user to see through the material.

18. The personal shade of claim 17, wherein the visor is configured to inhibit substantially all ultraviolet incident light from passing through the material.

19. The personal shade of claim 18, wherein the arm is configured to allow the user to position the visor to inhibit incident light from a given source direction.

20. The personal shade of claim 19, further comprising a clamp connected to the second end of the arm, wherein the clamp is configured to be repeatedly attached to and detached from an article of furniture.
